(19) United States
(12) Patent Application Publication
(10) Pub. No.: US 2018/0291870 A1
(43) Pub. Date: Oct. 11, 2018

(54) WIND TURBINE BACKUP POWER SUPPLY MONITORING

(71) Applicant: Moog Unna GmbH, Unna (DE)

(72) Inventors: Tobias Theopold, Unna (DE); Hilmar Strenzke, Aschaffenburg (DE)

(21) Appl. No.: 15/570,664

(22) PCT Filed: Apr. 29, 2016
(86) PCT No.: PCT/EP2016/059665

§ 371 Date: Oct. 30, 2017

(30) Foreign Application Priority Data
Apr. 30, 2015 (DE) 102015005509.7

(51) Int. Cl. F03D 7/02; F03D 17/00

(52) U.S. Cl. CPC F03D 7/0224; F03D 17/00; F03D 7/0264; F05B 2260/74; F03D 9/255; F05B 2260/80; F05B 2260/83; F05B 2270/107; F05B 2260/76

(57) ABSTRACT

A method for testing the condition of a backup power supply of an axis in a wind turbine, wherein the backup power supply has an associated voltage, the method comprising: electrically isolating the axis of the wind turbine from a grid power supply; discharging the backup power supply for a first period of time at a first predefined current; measuring a first value of the voltage; operating the axis using the backup power supply until the voltage reaches a predefined second value; discharging the backup power supply for a second period of time at a second predefined current; measuring a third value of the voltage; and calculating a parameter based on at least the first and third values, wherein the parameter is characteristic of the condition of the backup power supply.

### TECHNICAL FIELD OF THE INVENTION

The present invention relates to the operation of wind turbines, more particularly to monitoring backup power supply units for use in wind turbines.

### BACKGROUND TO THE INVENTION

Wind turbines typically comprise a plurality axes, each axis defined by a rotor blade, and a means for controlling the pitch of the rotor blades. In emergency situations, the pitch of the rotor blades can be altered such that the blades are put into a feathering position. In the feathering position the rotor blades are “taken out of the wind”, meaning that they oriented such that they act to retard the rotation of the rotor through air resistance, so as to put the wind turbine in an idle state quickly and safely. For example, if wind speed became too high, if there was a loss of power or if a fault was detected, the wind turbine can be put into a safe, idle mode to reduce the risk of damage to the turbine and injury to persons.

Power for controlling systems in a wind turbine (including the systems controlling blade pitch) is typically provided via a connection to a power grid. It is desirable that the pitch of the blades can still be controlled in order to put the blades into a feathering position even if there is a loss of grid power at the wind turbine. In order to achieve this, it is known to provide a backup power supply in the wind turbine, for example a battery or a high capacity capacitor (also known as a super capacitor). When there is a loss of power the backup power supply provides enough energy to pitch the blades into the feathering position. In this way the turbine can be put into an idle mode even if there is a failure in grid power supply.

It is desirable to monitor the condition of the backup power supply, to check that the backup can still provide sufficient energy to put the rotor blades into a feathering position in an emergency situation. Such condition monitoring aims to ascertain whether the backup power supply is still working efficiently, and whether or not it has developed a fault, and can provide a user with an indication whether the backup power supply requires repair or replacement. In order to test the condition of a backup power supply, it is known to perform a stress test, in which the backup power supply is discharged in conditions that replicate an emergency situation.

Known backup power supply condition monitoring techniques suffer from disadvantages in that they often require the wind turbine to be in an idle condition (i.e. the blades are put into a feathering position using the grid power supply before the stress test is performed). Whilst in an idle state, the wind turbine cannot produce power, thus it is desirable to wait until a period where wind speeds are very low and thus power generation would also be very low, before performing the stress tests.

In addition, known stress tests typically discharge the backup power supply completely, or to a large extent (i.e. an extent such that an amount of energy is delivered by the backup power supply that would be sufficient to put an associated rotor blade into a feathering position using a pitch drive motor), typically over a short time scale, for example between 1 s to 10 s. Repeated high discharge of the backup power supply over a short space of time (and the associated high charging that is required to recharge the backup power supply) can accelerate the aging of the backup power supply. For example, the capacity of a super capacitor, and the voltage and current it is able to deliver will naturally decrease over time, however repeated high discharge at a high rate will typically increase the rate that this reduction in capacity occurs. Accordingly the act of monitoring the condition backup power supply can itself result in the condition degrading at an accelerated rate.

### SUMMARY OF THE INVENTION

In order to address at least some of the issues mentioned above, there are provided pitch drive units, wind turbines and methods for testing the condition of a backup power supply of an axis in a wind turbine as defined by the appended claim set.

In accordance with a first embodiment of the present invention, there is provided a method for testing the condition of a backup power supply of an axis in a wind turbine wherein the backup power supply has an associated voltage, the method comprising: electrically isolating the axis of the wind turbine from a grid power supply; discharging the backup power supply for a first period of time at a first predefined current; measuring a first value of the voltage; operating the axis using the backup power supply until the voltage reaches a predefined second value; discharging the backup power supply for a second period of time at a second predefined current; measuring a third value of the voltage; and calculating a parameter based on at least the first and third values, wherein the parameter is characteristic of the condition of the backup power supply.

Preferably the first and second currents correspond to a current provided by the backup power supply in an emergency situation, in which the backup power supply powers a pitch drive motor in order to pitch an associated rotor blade into a feathering position. For example such a high current may have a root mean squared (RMS) value in the range 20-30 A (DC) at backup power supply voltage of 420V.

In the above method the first and second discharge currents may be obtained by drawing an appropriate current by the pitch drive motor (for example by causing the pitch drive motor to repeatedly change the pitch of the rotor blade back and forth by small amounts). Alternatively, the first and second discharge currents may be obtained by drawing an appropriate current by a resistive load actuated by power electronics (for example a chopper resistor) included in the axis of the wind turbine. As a further alternative, the current can also be drawn using an output bridge of the pitch drive, wherein the operating bridge inputs current to the pitch drive motor (preferably inputting the current to stator electromagnets) such that no torque is generated in the motor—i.e. the current drawn does not cause the motor to move the rotor blade, rather it just causes resistive losses in the motor.

By providing two short periods of high current discharge, the method above simulates the stresses placed on a backup power supply during an emergency situation in which it is required to provide enough energy to put an associated rotor blade into a feathering position when power from a grid supply is not available. Thus the method determines whether the backup power supply can operate under such stress without breaking down.

By performing the high discharge at the start and end of the testing procedure, the backup power supply is stressed in two different voltage ranges—thus it is beneficially determined whether the backup power supply can operate without breaking down over a range of different voltages, and additionally supply sufficient current for emergency blade feathering over a range of voltages.

Because the high discharge is only performed during two short bursts and the backup power supply is not fully discharged, the backup power supply is aged less by the testing process.

This leads to an increase in the overall lifetime of the backup power supply relative to conventional testing techniques. Furthermore, the method above also allows the wind turbine to perform normal power generation for large parts of the testing procedure, thus increasing the amount of power that can be generated by the wind turbine relative to testing regimes that require the wind turbine to be put into an idle mode, or to only allow pitch control of axes not being tested during the testing procedure. Indeed the present method can be implemented arbitrarily often with minimal detrimental effect to power generation.

In accordance with a second embodiment of the present invention, there is provided a pitch drive unit for a wind turbine comprising: a pitch drive motor; a backup power supply; a connection to a power grid; and control logic. The control logic is configured to: a) monitor the voltage across the backup power supply; b) monitor the current through the backup power supply; c) electrically isolate at least the backup power supply and the pitch drive motor from the connection to the power grid; d) cause the pitch drive motor to operate according to normal power generation procedures, wherein the pitch drive motor draws a first variable current from the backup power supply; e) discharge the backup power supply at a second variable current over a first period of time, wherein the second variable current is chosen by the control logic such that the first and second variable currents sum to a substantially constant value of current during the first period of time; f) calculate a characteristic of the backup power supply based on the monitored voltage and current; and g) compare the characteristic to a predefined threshold.

By ensuring that the first and second variable current sum to a substantially constant current during the first time period, the second embodiment advantageously allows for a single period of high current discharge to provide enough information to characterise the condition of the backup power supply, whilst simultaneously allowing normal power generation procedures to be implemented at the pitch drive motor. This has the benefit that the amount of time the backup power supply undergoes high discharge stress during testing can be reduced, thus decreasing undesirable effects of aging and improving the longevity of the backup power supply, whilst at the same time increasing the amount of time that the wind turbine can generate power.

In some examples, the second variable current is drawn by a resistive load, actuated by power electronics, wherein the power electronics dynamically control the actuation of the load such that the load can draw the desired variable current. For instance, the second variable current can be drawn by a chopper resistor. In other examples the second variable current is drawn by an electromagnet stator at the DC pitch drive motor. For example an operating bridge or other suitable electronics can cause the second variable current to flow through the stator at a phase such that there is no torque generated in the pitch drive motor due to the second variable current.

Preferably, if the calculated characteristics, for example capacitance or internal resistance (also known as equivalent series resistance), do not satisfy predefined criteria, the backup power supply is deemed to require maintenance or replacement. In this case, preferably all the rotor blades at the wind turbine are put into a feathering position and the connection with the grid supply is re-established. Preferably, if the calculated characteristics satisfy the predetermined criteria, either: a) the test procedure is ended, the connection with the grid supply is re-established, the backup power supply recharges using power from the grid supply, and normal power generation procedures are performed; or b) the discharge, measurement, calculation and comparison steps are repeated for a different backup power supply voltage range (for example repeating the steps after a delay during which operation of the pitch drive motor has further discharged the backup power supply at much lower currents than an emergency discharge current), advantageously characterising the backup power supply over different voltage ranges.

### BRIEF DESCRIPTION OF THE DRAWINGS

Further aspects, features and advantages of the invention will be apparent from the following description of preferred embodiments, presented by way of example only, and by reference to accompanying drawings wherein:

FIG. 1 shows a schematic of components in pitch drive system for a wind turbine.

FIG. 2A shows a method for testing the condition of a backup power supply in accordance with a first embodiment of the present invention.

FIG. 2B shows an example of how various quantities change with time during testing the condition of a backup power supply in accordance with a first embodiment of the present invention.

FIG. 3A shows a flow diagram illustrating a method 300 for testing the condition of the backup power supply in accordance with a second embodiment of the present invention.

FIG. 3B shows an example of how various quantities change with time during testing the condition of a backup power supply in accordance with a second embodiment of the present invention.

FIG. 4 is a schematic of a pitch drive unit according to an example of the second embodiment of the present invention.

### DETAILED DESCRIPTION

Illustrative Wind Turbine

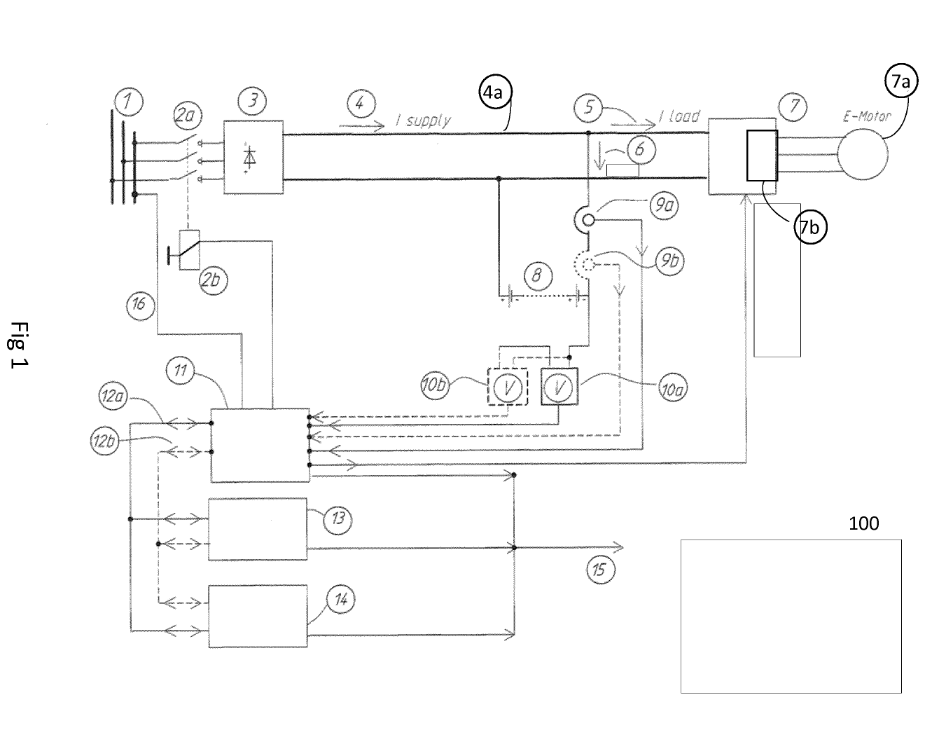

FIG. 1 shows a schematic of a pitch system of a wind turbine 100 that can be operated in accordance with the embodiments of the present invention. FIG. 1 shows a connection to a power grid 1 that is electrically connected to the wind turbine components via a switch. The switch is configured to isolate the wind turbine components electrically from the grid power supply during backup supply condition monitoring. As shown in FIG. 1, the switch is a contactor comprising a plurality of contacts 2a and an excitation coil 2b. Advantageously, a contactor is able to be operated electronically and can thus be operated remotely—this allows condition monitoring to be performed remotely and removes the need for an engineer to be present at the wind turbine during testing. Since wind turbines are often located in relatively inaccessible places (for example, offshore installations) avoiding the need to send engineers to turbines is advantageous both in terms of cost and engineer safety. Whilst a contactor or a similar electronically controlled switch is preferred, the skilled person will appreciate that the following condition monitoring techniques may be performed using any suitable switch known in the art. An AC/DC converter 3 is provided to convert power from the power grid 1 to direct current (DC). A DC supply current 4 is then provided to other components in the wind turbine via a power connection 4a. AC/DC converter 3 may comprise a rectifier, and more preferably comprises an intelligent rectifier having the ability to limit/control the current being output to other components in the wind turbine during conversion to DC. In some examples the AC/DC converter 3 has the ability to electrically isolate the other components in the wind turbine, thereby providing the functionality of the switch (for example, through the use of an intelligent rectifier).

The pitch system of a wind turbine comprises at least one pitch drive motor 7a. The pitch drive motor 7a is operably connected to a rotor blade, and is configured to change the pitch of the rotor blade according to a control signal provided to the pitch drive motor. In normal operation, the pitch of the rotor blade is altered so as to provide efficient power generation, and control the speed at which the rotor rotates and the current produced by the wind turbine. For example the pitch of a particular rotor blade may be chosen based on wind speed for example. Preferably the control signal is provided by axis control logic 11 associated with the rotor blade. In normal operation, the pitch drive motor 7a draws a load current 5 from power connection 4a when altering the pitch of the rotor blade. The pitch drive motor 7a is connected to a matched load converter 7. The matched load converter 7 preferably comprises a resistive load (such as a chopper resistor) and power electronics and an output bridge 7b. Output bridge 7b is preferably configured to control the current drawn by the pitch drive motor 7a, and the direction in which the motor rotates. A chopper resistor (also known as a brake chopper) is an electrical switch with a resistive load configured to brake the pitch drive motor 7 by selectively drawing current through the resistive load when voltage exceeds a certain value to dissipate excess energy. The assembly comprising the load converter 7 and the pitch drive motor (and preferably also the output bridge and resistive load/power electronics) is also referred to as a pitch converter.

Preferably the wind turbine comprises a plurality of axes, that is to say a plurality of rotor blades. Preferably a separate pitch drive motor is provided for each of the rotor blades, thereby allowing the pitch of each rotor blade to be controlled independently. Each axis is provided with control logic (for example a first axis control logic 11, a second axis control logic 13 and third axis control logic 14 in a three axis wind turbine), wherein the control logic associated with the axis is configured to control the corresponding pitch drive motor of that axis. The control logic 11, 13, 14 may be a processor, such as a microprocessor, or other appropriate processing circuitry. Preferably each axis control logic can communicate with the control logic of other axes via a bidirectional bus connection 12a, 12b. Furthermore, each axis control logic 11, 13, 14 is preferably connected via a control line 15, which when activated causes all axis control logic 11, 13, 14 to cause their respective pitch drive motors to feather the associated rotor blades. Each axis is provided with a power connection 4a to supply power in normal operation. In some examples, each axis comprises its own AC/DC converter 3.

The wind turbine also comprises a backup power supply 8. Backup power supply 8 is preferably a high capacity capacitor (such as a supercapacitor). The capacity of the capacitor is preferably chosen based at least in part on the dimensions of the rotor blade with which it is associated—a larger blade will require more energy (and therefore will require a large capacity capacitor) to change the pitch to put it into a feathering position. Preferably the capacitance of the backup power supply is such that enough energy can be stored to move the associated rotor blade from a pitch that is at the extreme opposite end of the range of possible pitch positions of the rotor blade from the feathering position, to the pitch corresponding to the feathering position. For example a wind turbine generating 3 MW having three rotor blades, a super capacitor having a capacitance of around 1 F to 2 F is preferably provided for each blade. Advantageously, such supercapacitors are capable of storing sufficient energy to bring the rotor blades into a feathering position in an emergency situation. Supercapacitors also have the advantage of having a relatively long lifetime, and thus require replacement less frequently—this is particularly advantageous when the wind turbine is situated in a location that is difficult to access, for example an offshore wind farm, in which case sending engineers to replace backup power supplies can be expensive. As an alternative, other backup power supplies could be used, for example electrochemical batteries. The backup power supply 8 is also connected to the power connection 4a. In normal operation, the backup power supply draws a charging current 6 used to charge the backup power supply and maintain the charge stored in the backup power supply. In an emergency situation in which grid power supply is lost, the backup power supply 8 discharges through the pitch drive motor 7a, thereby providing enough energy to alter the pitch of the associated rotor blade to put the rotor blade into a feathering position.

Preferably a separate backup power supply 8 is provided for each axis of the wind turbine. For example in a three axis wind turbine, three backup power supplies are preferably provided, with each backup power supply connected to a respective pitch drive motor. Advantageously this provides redundancy in an emergency situation. In particular, it has been found that feathering two blades in a three blade wind turbine is sufficient to stop the rotation of the rotor and put the turbine into an idle mode. Thus is one of the backup power supplies 8 were to fail, two backup power supplies powering two pitch drive motors would be enough to put the wind turbine into an idle mode.

In order to facilitate monitoring of the condition of the backup power supply 8, the current and voltage associated with the backup power supply are measured. The current being drawn by the backup power supply during charging and the current provided by the backup power supply when being discharged is measured using a current transducer 9a. In some examples, an additional current transducer 9b is provided to verify the measurement of the other current transducer 9a. The voltage across the battery is measured at a voltage measurement point 10a.

In some examples an additional voltage measurement point 10b is provided to verify the measurement of the other voltage measurement point 10a.

Preferably some or all of the components discussed above can be provided in a single pitch drive unit (not shown). Preferably the pitch drive unit comprises at least a power connector 4a, a load converter 7 and associated pitch drive motor 7a (wherein either the load converter 7 or the pitch drive motor 7a preferably comprise a chopper resistor—or other power-electronics actuated resistive load—and an output bridge 7b), a backup power supply 8, one or more current transducers 9a, 9b, and one or more voltage measurement points 10a, 10b. Preferably the pitch drive unit also comprises axis control logic 11. In some examples the pitch drive unit also comprises an AC/DC converter 3, and optionally a switch (preferably a contactor comprising a plurality of contacts 2a and an excitation coil 2b).

### First Embodiment of the Invention

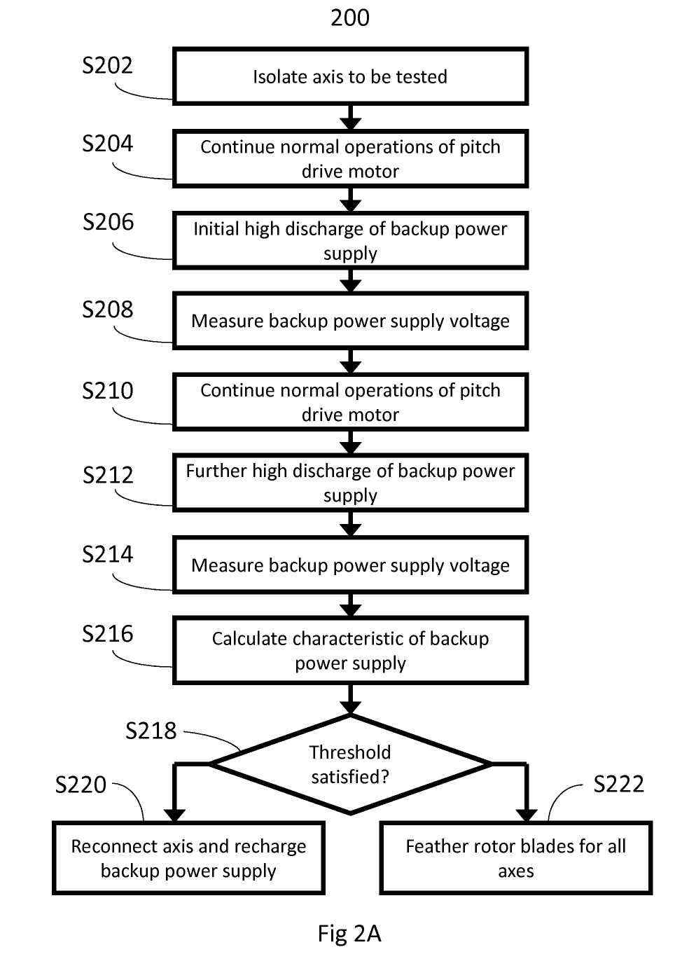

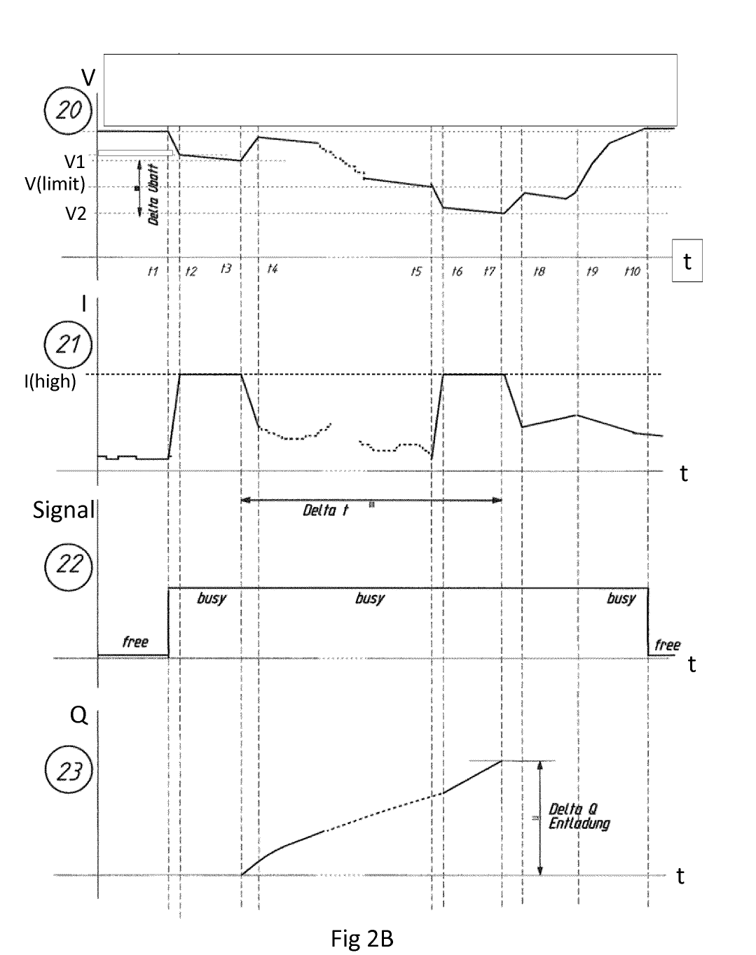

FIG. 2A shows a flow diagram illustrating a method 200 for testing the condition of the backup power supply in accordance with the present invention. FIG. 2B shows an example of how backup power supply voltage 20, backup power supply current 21, a control unit output signal 22 and charge discharged from the backup power supply evolve over time during the execution of the method 200 of FIG. 2A. Preferably the voltage across the backup power supply 20 and the current through the backup power supply 21 are monitored throughout the testing method 200 by the axis control logic 11.

The method 200 is preferably performed using a pitch drive system for a wind turbine 100 and/or a pitch drive unit as described above in relation to FIG. 1.

Preferably method 200 begins when the wind turbine is performing normal power generation procedures, i.e. the respective pitch drive motor 7a of each axis is controlling the pitch of the associated blade in accordance with the signal from the associated control logic 11, and the pitch drive motor is connected to the power grid supply 1. In such a state, the wind turbine may be generating power if wind speed is sufficient. FIG. 2B shows exemplary characteristics of one of the backup power supplies 8 when the wind turbine is performing normal power generation procedures during time t0 to time t1. The voltage 20 across the backup power supply 8, and the current 21 through the backup power supply 8 is substantially constant during t0-t1. It will be appreciated that a relatively small current may be drawn by the backup power supply 8 in order to maintain the full charge held at the backup power supply. The charge 23 discharged by the backup power supply 8 during t0-t1 is substantially zero. During time t0-t1 control logic 11 preferably provides a signal 22 via the bidirectional bus connection 12a, 12b indicating that the axis is “free”, that is to say it is available to have its backup power supply 8 tested.

At step S202, an axis to be tested is electrically isolated from the grid power supply 1 at time t1. Preferably this is performed via a switch such as contactor 2a, 2b, however this may also be achieved by disabling the AC/DC converter 3, such that current flow from the power supply grid to the pitch drive motor 7a and the backup power supply 8 is prevented. At step S204, preferably also executed at time t1, normal operations of the pitch drive motor 7a of the axis being tested are continued, wherein the backup power supply 8 provides the current needed by the pitch drive motor to perform normal operations. In other words the pitch of a rotor blade is dynamically altered in a normal manner according to a control signal provided to the pitch drive motor 7a. In step S206 (preferably also executed at time t1) the load converter 7 is also configured to draw current from the backup power supply 8. Advantageously, performance of steps S202, S204 and S206 at the same time t1 reduces the time taken to perform the backup power supply test.

During step S206, the current drawn from the backup power supply by the load converter 7 and/or the pitch drive motor 7a is increased during a short time period t1-t2 to a predefined high current I(high). The predefined high current I(high) is a backup power supply discharge current that approximates the high current that would be drawn from the backup power supply 8 during an emergency situation in which the backup power supply 8 would be required to drive the pitch drive motor 7a to feather the associated rotor blade. For example, a suitable predefined current I(high) may have an RMS value in the range 20-30 A for a super capacitor having a capacitance of 1-2 F when in good condition (depending on the turbine and blade design). The time taken to increase the discharge current from substantially zero to the predefined high current t1-t2 is preferably similar to the time that would be taken to increase the discharge current from the backup power supply in an emergency situation. For example, the time t1-t2 may be 500-3000 ms for a super capacitor having a capacitance of 1-2 F when in good condition. Beneficially, by replicating one or more of the conditions placed upon the backup power supply during an emergency situation, useful indications of the backup power supply's performance in such situations can be extracted. Furthermore, using a high discharge current I(high) provides the additional benefit in that, if the backup power supply condition was poor, the high discharge could induce breakdown of the backup power supply. Thus the testing method could induce failure in poor backup power supplies, easily identifying that the power supply requires repair or replacement—if this were to occur, the testing procedure would end, the axis being tested would be reconnected to the power grid supply 1, and all rotor blades would be put into a feathering position to put the wind turbine in an idles state until the backup power supply in question had been repaired/replaced.

The high current I(high) is discharged from the backup power supply 8 for a predetermined first time period t2-t3. The predetermined first time period t2-t3 is typically brief, for example it has been found that stressing the backup power supply in this manner for first time periods t2-t3 of around 500-3000 ms are sufficient for adequately quantifying the condition of the backup power supply 8.

In one example, the high discharge current is obtained by discharging the backup power supply through the pitch drive motor. During the first period t2-t3, the pitch drive motor 7a is preferably configured rotate the rotor blade a small distance (for example 2 degrees) in a first direction of rotation, then rotate the rotor blade the same or a similar distance in the reverse direction of rotation—this is then repeated to provide a series of rotations of the rotor blade back and forth during the first discharge period t2-t3, thereby drawing enough current at the pitch drive motor 7a to be able to discharge the backup power supply 8 at the desired current. In this example the current drawn by the pitch drive motor 7a is substantially the same as the discharge current of the backup power supply—current is drawn by other components in the axis (for example circuitry for controlling the rotation speed/direction of the pitch drive unit), however this is negligible in comparison to the discharge current needed to replicate the current provided by the backup power supply 8 in an emergency situation. For example, the discharge current provided by the backup power supply in the first time period t2-t3 has an RMS value of the order of 20-30 A, and of this only a negligible amount is drawn by components other than the pitch drive motor. Advantageously, by only performing a high current discharge of the backup power supply 8 for a brief amount of time in this manner, the movement of the pitch drive motor 7a relative to its previously adjusted position (i.e. its position at t1) is small, and accordingly the change in pitch of the associated blade from its previously adjusted pitch (i.e. its pitch at t1) is also small—advantageously this prevents the introduction of a large asymmetry between the respective pitch of the different rotor blades, which can result in undesirable mechanical stresses/strains being placed on the structure and components of the wind turbine.

In other examples, the high discharge current can be achieved during the first time period t2-t3 by configuring the load converter 7 to draw the required current from the backup power supply. In one example the load converter 7 is configured to cause the high discharge current to be drawn by a resistive load actuated by power electronics (such as a chopper resistor) included at the load converter 7. In another example, an output bridge (or other suitable circuitry) is configured to draw the high discharge current by inputting a field current into the pitch drive motor 7a, such that no torque is generated in the pitch drive motor 7a—an appropriate means is discussed in more detail in relation to the second embodiment, which may be combined with the present embodiment. The current drawn by the load converter 7 during the first time period t2-t3 is substantially the same as the current discharged by the backup power supply 8—other components in the axis only draw negligible currents relative to the discharge current.

At the end of the predetermined first time period t2-t3 the load converter 7/pitch drive motor 7a/other suitable means is configured to stop drawing the predefined high current I(high) (see for example time t3 in FIG. 2B).

At step 208, the collapsed voltage V1 of the backup power supply is measured via voltage measurement point 10a (and additional voltage measurement point 10b, if provided) and stored in axis control logic 11. This measurement of the collapsed voltage is preferably taken at the same time that the discharge of the power supply at the predefined high current I(high) ends, for example time t3 in FIG. 2B.

Subsequently, normal operation of the pitch drive motor is continues in step S210, t4, during which the pitch drive motor draws current required for performing normal pitch adjustment of the rotor blade in accordance with a control signal (for example from control logic 11)—the high current I(high) is not drawn. The normal operation continues during a second time period t4-t5. The pitch drive motor 7a remains isolated from the power grid supply 1, and therefore draws current from the backup power supply 8 in order to alter the pitch of the associated rotor blade to control current generated by the wind turbine/rotor rotation speed/etc. The current drawn by the pitch drive motor 7a depends on the degree of, and frequency of, required rotor blade pitch adjustments, which in turn depend on the wind conditions. The backup power supply 8 is discharged in accordance with the current drawn by the pitch drive motor 7a performing normal operations, until the voltage across the backup power supply falls below a pre-set lower voltage limit V(limit), t5. The time taken to reach this limit will depend on the current drawn by the pitch drive motor 7a, which in turn depends on wind conditions. Advantageously this second period t4-t5 of the backup testing method allows power to be generated by the wind turbine in a normal manner, thus minimising any interruption to power generation caused by backup power supply testing.

The pre-set lower voltage limit V(limit) is preferably chosen such that the backup power supply 8 still can still deliver sufficient current to put the associated blade in a feathering position in the event of an emergency situation. As an example, the lower voltage limit can be chosen based on the amount of stored charge required to feather the associated rotor blade and presupposed properties of the backup power supply. Such a presupposed property may be an estimated capacitance corresponding to a backup power supply in poor condition, advantageously ensuring that the backup power supply contains sufficient charge for emergency feathering even if it is not in a good condition.

When the pre-set lower voltage limit V(limit) is reached t5, a further high current discharge of the backup power supply is initiated in step S212. As in step S204, normal operations of the pitch drive motor are continued, and a high current is drawn by the load converter 7/pitch drive motor 7a. Preferably the drawing of a high current from the backup power supply 8 is performed in the same manner as described in the above examples in relation to step S206, with the current increasing from its value at time t5 to I(high) in the period t5-t6. Preferably time period t5-t6 is short as described above in relation to time period t1-t2. Again, this high discharge current and short time period t5-t6 advantageously mimics the conditions placed on the backup power supply 8 in the event of an emergency situation. The backup power supply 8 is discharged at the high current I(high) for a predefined third time period t6-t7. As described above in relation to step S206, the third time period t6-t7 for which the backup power supply 8 is discharged at I(high) is typically short, for example 500-3000 ms, which prevents asymmetry arising between the pitch of different rotor blades whilst applying sufficient stress to the backup power supply 8 to gather useful information regarding its condition. When discharge of the backup power supply 8 at the high current I(high) is ceased t7, the voltage V2 across the backup power supply 8 is measured via voltage measurement point 10a (and additional voltage measurement point 10b, if provided) and stored in axis control logic 11. Preferably this voltage V2 is measured at the same time the high current discharge of the backup power supply 8 ends t7. It is noted that whilst FIG. 2B shows that the current discharged by the backup power supply 8 is the same for both the initial high current discharge in the first time period t2-t3 and the second high current discharge in the third time period t6-t7, different high currents could be drawn for the initial and second high current discharges.

In step S216 one or more characteristic properties of the backup power supply 8 are calculated based on the measured voltages V1, V2. For example, in the case that the backup power supply 8 is a supercapacitor, the capacitance of the backup power supply 8 can be calculated by integrating the current discharged between the times at which the voltages V1, V2 were measured (for example the time period t3-t7 in FIG. 2B) in order to extract a net charge DeltaQ discharged by the backup power supply, and dividing this value by the difference in measured voltages DeltaUbatt. Other characteristic properties of the backup power supply may derived using the measured voltages V1, V2.

Ordinarily, the internal resistance of the backup power supply 8 must be measured/calculated for situations in which the high discharge currents vary over time (for example if I(high) does not remain constant during times t2-t3 and/or t6-t7, for example due to variations in the current drawn by the pitch drive motor as normal adjustments are made to the rotor blade pitch in accordance with control signals to ensure optimal power generation). The internal resistance must ordinarily be taken into account when calculating the capacitance (and certain other properties) of the backup power supply 8 based on the voltage across the backup power supply 8 and the total charge discharged. Advantageously, by measuring V1 at t3, and measuring V2 at t7 (that is, by measuring the voltage across the backup power supply 8 at the end of each high discharge period) and dividing the net charge DeltaQ by the difference DeltaUbatt, the internal resistance of the backup power supply 8 is effectively compensated for without requiring it to be calculated—put differently, by using the particular measurements of method 200, any contribution to the voltage 20 across the backup power supply 8 due to internal resistance can be approximated as cancelling out when calculating capacitance of the backup power supply 8. Accordingly, the method 200 has additional benefits in terms of being computationally less complex (with commensurate benefits in terms of reduced demand for processing resources).

In step S216, one or more characteristic properties of the backup power supply 8 are compared to predetermined threshold values to determine whether the backup power supply 8 is operating within safety parameters. For example, a capacitance of the backup power supply 8 is compared to a predetermined threshold capacitance. If the characteristic property satisfies the predetermined threshold, it is determined that the backup power supply is in a condition within tolerance (and it is capable of providing enough energy to feather the associated rotor blade in an emergency situation), and the method proceeds to step S220 in which the axis being tested is reconnected to the power grid supply 1, which provides current to drive the pitch drive motor 7a and recharge the backup power supply 8 (see for example times t8-t10 in FIG. 2B). If the characteristic property does not satisfy the predetermined threshold, it is determined that the backup power supply requires repair or replacement, and the method proceeds to step S222 in which the axis being tested is reconnected to the power grid supply 1, and all rotor blades are put into the feathering position, thereby putting the wind turbine into an idle state until the backup power supply 8 in question has been repaired or replaced. Preferably the axis control logic 11 of the axis being tested causes its associate rotor blade to move into a feathering position via pitch drive motor 7a, and sends a control signal to the other axis control logic 13, 14 via control line 15 that causes the other axis control logic 13, 14 to feather their respective rotor blades via their respective pitch drive motors.

Reference values for use in the method above be collected by testing characteristics of a similar backup power supply, being of the same model as the backup power supply in the wind turbine being monitored, using suitable test equipment in a known manner. This may include measuring the capacitance of the similar backup power supply, and determining how properties of the similar backup power supply change as the similar backup power supply ages—aging of the similar backup power supply may be deliberately accelerated by repeatedly fully charging and fully discharging the similar backup power supply. From such an analysis of a similar backup power supply, suitable values for use as the voltage limit V(limit), and the predetermined threshold values can be determined.

Preferably, if the capacitance of the backup power supply 8 as calculated using the method above is greater than or equal to a higher capacitance threshold value, the capacitance of the backup power supply 8 is deemed to be acceptable. If the capacitance of the backup power supply 8 is less than the higher capacitance threshold but greater than or equal to a lower capacitance threshold value, preferably a warning is produced, which is preferably transmitted to a wind turbine control facility indicating that the backup power supply 8 may require imminent replacement or repair. If the capacitance of the backup power supply 8 is less than the lower capacitance threshold, preferably the backup power supply 8 is determined to have failed, and all blades of the wind turbine are put into a feathering position thereby putting the wind turbine into an idle mode.

As an example, a reference value of capacitance can be used to define higher and lower threshold values for capacitance, wherein the reference value is either obtained from analysis of similar backup power supplies or datasheet values as discussed above. In one example, the higher capacitance threshold is 80% of a reference value of capacitance, and the lower capacitance threshold is 70% of the reference value of capacitance, wherein the reference value of capacitance is representative of a hypothetical backup power supply in good condition.

Advantageously the above method allows accurate characterisation of backup power supply condition, whilst minimising aging of the backup power supply. By providing two short periods of high discharge, the method replicates the stresses placed on a backup power supply during an emergency situation, and thus it is determined whether the backup power supply can operate under such stress without breaking down. By performing the high discharge at different points during the testing procedure, such as at the start and end of the testing procedure, the backup power supply is stressed at two different voltage ranges—thus it is beneficially determined whether the backup power supply can operate without breaking down over a range of different voltages, and supply sufficient current over a range of voltages. Because the high discharge is only performed during two short bursts and the backup power supply is not fully discharged, the backup power supply is aged less by the testing process, and accordingly the overall lifetime of the backup power supply is increased. Furthermore, the method above also allows the wind turbine to perform normal power generation for substantially all of the testing procedure, thus increasing the amount of power that can be generated by the wind turbine. Indeed the present method can be implemented arbitrarily often with minimal detrimental effect to power generation.

During the testing procedure t1-t10 the axis control logic 11 of the axis being tested sends a signal 22 to the other axis control logic 13, 14 via bidirectional bus 12a, 12b indicating that the axis is “busy”. On receiving this signal, the other axis control logic 13, 14 determine that the other axes should not begin a testing procedure. Advantageously this provides that only one axis is tested at any one time, thus making sure that enough blades can be put into a feathering position to put the wind turbine into an idle mode in the event of an emergency situation.

As noted above, the present testing method can be carried out arbitrarily often. The testing method may be instigated remotely. For example a remote computing system can transmit a signal via a communications line (not shown) to the axis control logic 11, wherein the signal causes the axis control logic 11 to initiate testing for the backup power supply 8 of that axis. Advantageously this allows for on-demand backup power supply testing without the need to send maintenance personnel to the wind turbine in question. Alternatively, testing could be initialed automatically locally at the wind turbine. For example testing cycles may be initiated at pre-set time intervals by the axis control logic 11, 13, 14. In this embodiment, it is preferred to provide a collision priority list (preferably implemented by control logic 11, 13, 14), which, in the event that test cycle start times for two or more axes coincides (for example due to the provision of separate independent internal clocks that govern the time intervals for testing, for example in each separate axis control logic 11, 13, 14), shifts the test start time for one or more of the backup power supplies such that the start times no longer coincide.

The above embodiment is described as including two periods of high current discharge. In alternative embodiments, one or more than two periods of high current discharge are provided. Furthermore, each of the one or more periods of high discharge may be performed at the start of the test procedure as described in step S206, or at the end of the test procedure as described in step S212, or at other times during the test procedure. In such embodiments, the remaining steps of method 200 are preferably performed as described above, although depending on the number of periods of high discharge current, calculations of capacitance may need additional measurement of the internal resistance of the backup power supply, as would be appreciated by the skilled person.

### Second Embodiment of the Invention

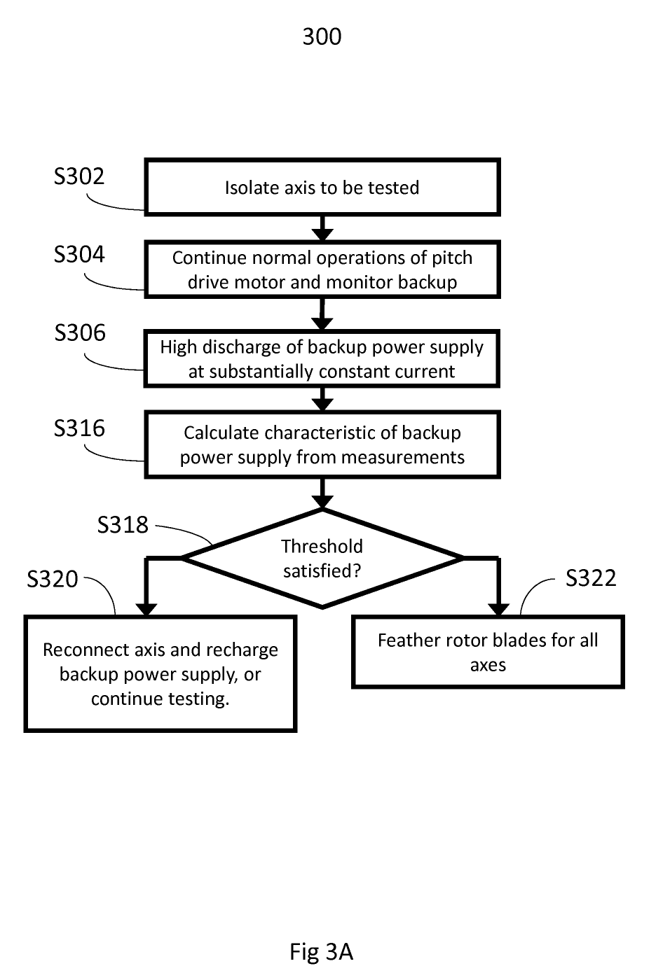

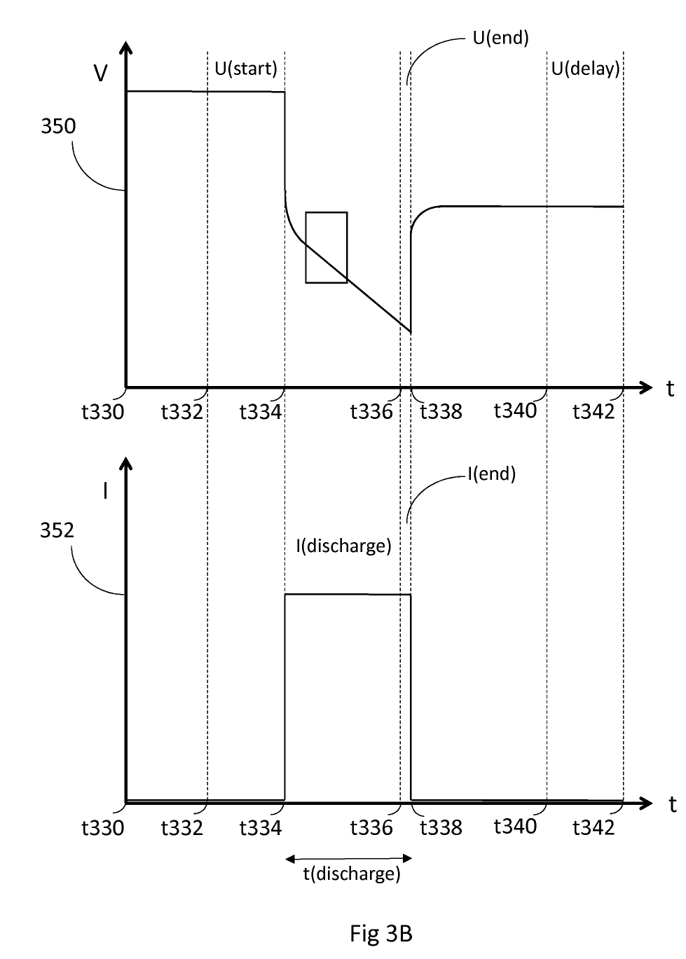

FIG. 3A shows a flow diagram illustrating a method 300 for testing the condition of the backup power supply in accordance with a second embodiment of the present invention. FIG. 3B shows an example of how voltage 350 across the backup power supply 8, and current 352 drawn from the backup power supply 8 change with time during testing the condition of a backup power supply in accordance with the second embodiment of the present invention.

The method 300 is preferably performed using a pitch system of a wind turbine 100 and/or a pitch drive unit as described above in relation to FIG. 1.

In summary, this embodiment provides a substantially constant high discharge current of the backup power supply for a certain period, whilst allowing the pitch drive motor 7a to perform normal operations, that is, alter the pitch of the associated rotor blade in accordance with a control signal to ensure optimal power generations in the same manner as would be performed when a backup testing procedure is not being performed. It is noted that this second embodiment may be implemented as part of the first embodiment above. In particular, the method for providing a period of high, constant, discharge current as described in detail below can be used in place of the periods of high discharge current as described above in relation to FIG. 2A (see steps S206 and S212).

In one example, method 300 begins (for example at a time t330) when the wind turbine is performing normal power generation procedures, i.e. the respective pitch drive motor 7a of each axis is controlling the pitch of the associated blade in accordance with the signal from the associated control logic 11, and the pitch drive motor is connected to the power grid supply 1. In such a state, the wind turbine may be generating power if wind speed is sufficient. Whilst performing normal power generation procedures, a voltage across the backup power supply 8, and a current through the backup power supply 8 are substantially constant. It will be appreciated that a relatively small current may be drawn by the backup power supply 8 in order to maintain the full charge held at the backup power supply. The charge discharged by the backup power supply 8 whilst performing normal power generation procedures is substantially zero. Whilst performing normal power generation procedures, control logic 11 preferably provides a signal via the bidirectional bus connection 12a, 12b indicating that the axis is “free”, that is to say is available to have its backup power supply 8 tested. Alternatively, method 300 begins when an axis to be tested is already electrically isolated from the grid power supply 1—for example when being implemented in the context of the method 200 of FIG. 2, the method 300 may begin at a time when high discharge current is required (for example times t1 and/or t7) or shortly beforehand.

If the axis to be tested is not already electrically isolated, the method 300 starts at step S302. At step S302, the axis to be tested is electrically isolated from the grid power supply 1. Preferably this is performed via a switch such as contactor 2a, 2b, however this may also be achieved by disabling the AC/DC converter 3, such that current flow from the power supply grid to the pitch drive motor 7a and the backup power supply 8 is prevented.

Though it is preferable for the entire axis to be electrically isolated from the grid power supply, it will be appreciated by the person skilled in the art that it may be sufficient to simply isolate the backup power supply 8 and the pitch drive motor 7a/load converter 7 from the grid power supply.

After step S302, the pitch drive motor 7a is configured to continue normal operations at step S304. Such normal operations comprise the pitch motor receiving instructions (for example from control logic 11) to continue dynamically controlling the pitch of the associated rotor blade in the same manner as during normal power generation procedures. As the pitch drive 7a is no longer electrically connected to the grid power supply 1, the pitch drive motor 7a draws current from backup power supply 8 in order to perform normal operations. Steps S302 and steps S304 are preferably performed at concurrently, such that normal operations of the pitch drive motor 7a are substantially continuous as the grid power supply is disconnected, thereby increasing the amount of time during which wind turbine generates power. Optionally (depending on which properties of the backup power supply are to be quantified), the voltage 350 across, and the current 352 discharged by the backup power supply 8 are also monitored, and are continued to be monitored throughout the following steps. Monitoring of the voltage and current is preferably performed by the control logic 11, for example via one or more current transducers 9a, 9b and one or more voltage measurement points 10a, 10b.

The method then proceeds to step S306, in which the backup power supply 8 is discharged at a high current, whilst normal operations of the pitch drive motor 7a continue (see for example times t334 to t338 in FIG. 3B). During step S306, the current drawn from the backup power supply by the load converter 7 and/or the pitch drive motor 7a is increased during a short time period to a substantially constant predefined high current. The substantially constant predefined high current is a backup power supply discharge current that approximates a high current that would be drawn from the backup power supply 8 during an emergency situation in which the backup power supply 8 would be required to drive the pitch drive motor 7a to feather the associated rotor blade. For example, a suitable substantially constant predefined current may be in the range 20-30 A (for example the substantially constant predefined current may have an RMS value in the range 20-30 A) for a super capacitor having a capacitance of 1-2 F (depending on the turbine and blade design) when in good condition. The time taken to increase the discharge current from substantially zero to the substantially constant predefined high current is preferably similar to the time that would be taken to increase the discharge current from the backup power supply in an emergency situation. For example, the short time period may be 500-3000 ms for a super capacitor having a capacitance of 1-2 F when in good condition.

Beneficially, by replicating one or more of the conditions placed upon the backup power supply during an emergency situation, useful indications of the backup power supply's performance in such situations can be extracted. Furthermore, using a high discharge current provides the additional benefit in that, if the backup power supply condition was poor, the high discharge could induce breakdown of the backup power supply. Thus the testing method could induce failure in poor backup power supplies, easily identifying that the power supply requires repair or replacement—if this were to occur, the testing procedure would end, the axis being tested would be reconnected to the power grid supply 1, and all rotor blades would be put into a feathering position to put the wind turbine in an idles state until the backup power supply in question had been repaired/replaced.

In order to provide that the high discharge current is substantially constant over the time during which the current is being discharged, the control logic 11, load converter 7 and/or pitch drive motor 7a are configured to account for the current required by the pitch drive motor to perform normal operations, and adjust the current to be drawn by other components accordingly.

Preferably the control logic 11 is configured to calculate, predict, or measure (via a suitable current measuring device as known in the art) the instantaneous current needed by the pitch drive motor to perform normal operations, i.e. the current required for the pitch drive motor to control the pitch of an associated rotor blade at each given moment in time whilst the high current discharge is being performed. The current required for the pitch drive motor for performing normal operations will depend on a number of factors, including for example wind speed and rotor blade position, size, etc., as would be appreciated by a person skilled in the art. The control logic 11 then configures the pitch drive motor 7a/load converter 7 such that the required current to perform normal operations is provided to the pitch drive motor by the backup power supply. The control logic preferably also calculates the instantaneous difference between the current required by the pitch drive motor 7a for normal operation added to any other currents required by the pitch drive unit (for example the current drawn by control logic 11) and the desired value of the substantially constant predefined high discharge current. The control logic 11 preferably then configures the pitch drive motor 7a/load converter 7 such that a current corresponding to the calculated difference is provided to the pitch drive motor 7a/load converter 7 by the backup power supply, in a manner that does not affect the normal operation of the pitch drive motor. In this manner, advantageously the total current drawn from the backup power supply is substantially constant during the time in which the high discharge occurs, whilst normal operation of the pitch drive motor can continue, thus resulting in little or no reduction in power generation at the wind turbine during the stress test.

In order to provide current corresponding to the calculated difference at the pitch drive motor 7a/load converter 7 in a manner that does not affect the normal operation of the pitch drive motor, several different current drawing means can be provided as discussed below.

In one example, the current corresponding to the calculated difference can be drawn by an electromagnet stator component of the pitch drive motor 7a (for example by configuring the control logic 11 to apply the current over the output bridge of the pitch drive motor 7a/load converter 7 such that the current flows through the stator). In this case the current is effectively a field current, that is, it does not cause the pitch drive motor 7a to generate torque. The energy associated with this current is dissipated through resistive losses in the stator component. This current is applied at an appropriate phase, such that the changes in current in the stator do not affect the operation of the pitch drive motor, i.e. a rotor component of the pitch drive motor rotates according to its normal operation, thus controlling the pitch of the associated rotor blade of the wind turbine in the normal manner. Advantageously, this example avoids the need to make additional changes to the pitch angle of the rotor blade.

In a second, less preferred example of current drawing means, the current corresponding to the calculated difference can be drawn by the rotor component of the pitch drive motor 7a, wherein the load converter 7/pitch drive motor 7a is configured such that this current is applied as a preferably constant frequency alternating current, such that the rotor component oscillates at a constant frequency. This in turn means that the pitch of the rotor blade changes according to the normal operation of the pitch drive motor, with an additional oscillation—in other words, at any given time during the high current discharge, the pitch of the rotor blade oscillates, the oscillation centering on the pitch corresponding the pitch during normal operation of the pitch drive motor 7a. Thus the pitch drive motor 7a is preferably configured rotate the rotor blade a small distance (for example 2 degrees) in a first direction of rotation, then rotate the rotor blade the same or a similar distance in the reverse direction of rotation, oscillating about a pitch angle corresponding to the pitch angle in normal operation, and repeat this operation, thereby drawing enough current at the pitch drive motor 7a to be able to discharge the backup power supply 8 at the desired current.

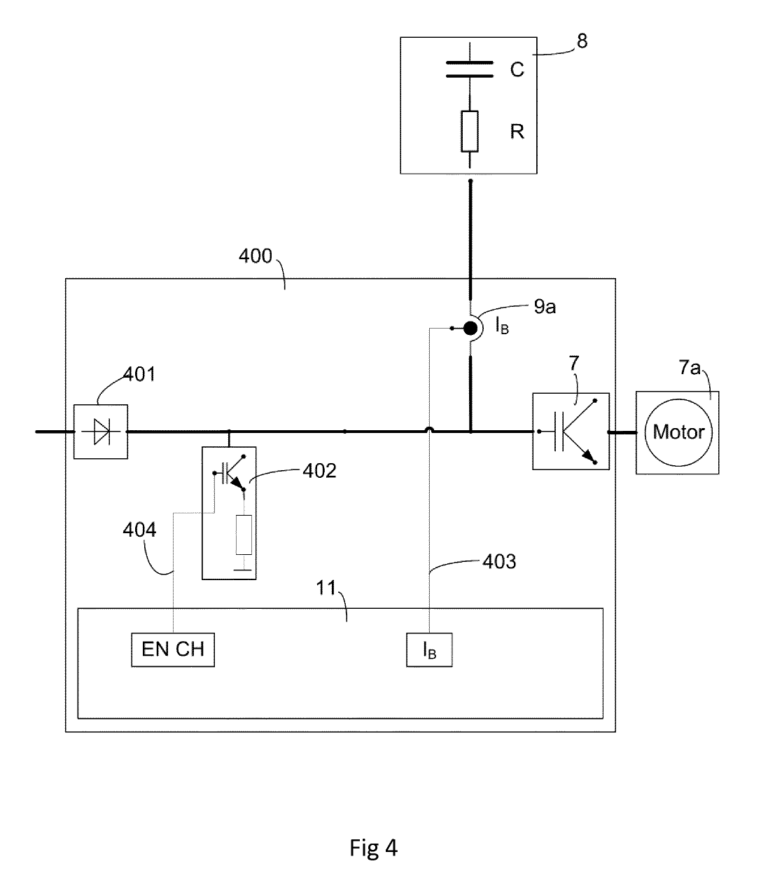

In a third, more preferred example of current drawing means, the current corresponding to the calculated difference can be drawn by a resistive load actuated by power electronics (for example a chopper resistor) present at the load converter 7/pitch drive motor 7a, wherein the power electronics are configured to vary the resistance of the resistive load such that the desired current is drawn. In this case, energy associated with this current is dissipated through resistive losses in the chopper resistor (or other resistive load). Advantageously, this example avoids the need to make additional changes to the pitch angle of the rotor blade. This third, more preferred example is discussed further in relation to FIG. 4. FIG. 4 is a schematic of a pitch drive unit 400, which preferably forms part of pitch system 100 as described above in relation to FIG. 1. Like reference numerals in FIGS. 1 and 4 correspond to like features. FIG. 4 shows a pitch drive unit 400 having a decoupling diode 401, a pitch drive motor 7a connected to a matched load converter 7, a backup power supply 8 (for example a super capacitor) having a capacitance C and an internal resistance R, a current transducer 9a, control logic 11 and a chopper resistor 402 (also known as a brake chopper). In this preferred example, the current output of the backup power supply 8 is measured at the current transducer 9a, which sends a signal to the control logic 11 via a first communication line 403. The control logic 11 determines the current drawn from the backup power supply 8 from the signal, and sends a control signal along a second communication line 404 to the chopper resistor 402, wherein the control signal configures the chopper resistor 402 to draw a particular current from the backup power supply 8 such that the total current output by the backup power supply 8 is the desired substantially constant discharge current.

The chopper resistor 402 practically acts as a shunt to the motor 7a. It may for example be pulse-width modulated, so that the chopper resistor is switched on and off rapidly so the current flowing through the motor 7a is supplemented by the current flowing through the chopper resistor 402 such that that the averaged sum of both currents is substantially constant. In order to be used for the purpose of enabling the drawing of the substantially constant high discharge current, the chopper resistor 402 must have an adequately low resistance (and other suitable properties) to handle the situation in which no current is drawn by the pitch drive motor 7a, in which case substantially all the high discharge current (for example 20-30 A) is drawn by the chopper resistor 402. Advantageously, the use of the chopper resistor 402 in this manner reduces costs, since a single component (the chopper resistor 402) is used for both the purpose of ensuring substantially constant current discharge during backup power supply testing, as well as for braking purposes at the pitch drive motor at other times. Thus this example is cheaper to implement that means involving the provision of different components for each task.

The chopper resistor 402 is a preferred way to control the current drawn from the backup power supply 8. The person skilled in the art will appreciate that if no chopper resistor 402 is available or is not suitable any other way of dissipating energy can be used to keep the discharge of the backup power supply constant, including providing specifically a load just for this purpose. As an additional example, current may be dissipated also by applying micro movements to the blade as explained earlier in connection with embodiment 1.

Returning now to FIGS. 3A and 3B, the substantially constant high current is discharged from the backup power supply 8 for a predetermined first time period (see for example times t334-t338 in FIG. 3B). The predetermined first time period is typically brief, for example it has been found that stressing the backup power supply in this manner for first time periods of around 2000 ms are sufficient for adequately quantifying the condition of a backup power supply 8. Preferably the first time period is between 1500 ms and 3000 ms. In one example the first time period is greater than 1500 ms. After the predetermined time period is complete, the control logic 11 is configured to end the high current discharge (see for example time t338), and subsequently the backup power supply 8 provides current for normal operation of the pitch drive motor 7a.

In step S316, one or more characteristic properties of the backup power supply 8 are calculated based on measurements of the voltage 350 and the current 352 of the backup power supply 8 taken during the test procedure. The measurements are preferably made by the control logic 11, for example via one or more current transducers 9a, 9b and one or more voltage measurement points 10a, 10b. Such calculations are discussed in more detail below. The characteristics are compared to predetermined threshold values to determine whether the backup power supply 8 is operating within safety parameters. For example, a capacitance of the backup power supply 8 is compared to a predetermined threshold capacitance.

If the characteristic property satisfies the predetermined threshold, it is determined that the backup power supply is in a condition within tolerance (and it is capable of providing enough energy to feather the associated rotor blade in an emergency situation), and the method proceeds to step S320 in which the axis being tested is reconnected to the power grid supply 1, which provides current to drive the pitch drive motor 7a and recharge the backup power supply 8. Alternatively, if it is desired to test the characteristic properties of the backup power supply at lower voltages, the axis can remain isolated and the backup power supply can be further gradually discharged by performing normal operation of the pitch drive motor for a predetermined period of time, or until the voltage 350 across the backup supply 8 reached a predefined limit (preferably corresponding to a voltage at which the backup power supply 8 is still capable of providing enough energy to put the associated rotor blade into a feathering position), and then repeating steps S304-S316.

If the characteristic property does not satisfy the predetermined threshold, it is determined that the backup power supply requires repair or replacement, and the method proceeds to step S322 in which the axis being tested is reconnected to the power grid supply 1, and all rotor blades are put into the feathering position, thereby putting the wind turbine into an idle state until the backup power supply 8 in question has been repaired or replaced. Preferably the axis control logic 11 of the axis being tested causes its associate rotor blade to move into a feathering position via pitch drive motor 7a, and sends a control signal to the other axis control logic 13, 14 via control line 15 that causes the other axis control logic 13, 14 to feather their respective rotor blades via their respective pitch drive motors.

Reference values for use in the method above be collected by testing characteristics of a similar backup power supply, being of the same model as the backup power supply in the wind turbine being monitored, using suitable test equipment in a known manner. This may include measuring the capacitance and/or internal resistance of the similar backup power supply, and determining how properties of the similar backup power supply change as the similar backup power supply ages—aging of the similar backup power supply may be deliberately accelerated by repeatedly fully charging and fully discharging the similar backup power supply. From such an analysis of a similar backup power supply, suitable values for use as the voltage limit, and the predetermined threshold values can be determined. Alternatively reference values may be obtained from datasheet values provided by the manufacturer of the backup power supply.

Beneficially, the method 300 allows for both capacitance and internal resistance to be calculated. To do this the following measurements are taken:
the voltage across the backup power supply 8 immediately before the period of high current discharge starts U(start) (for example voltage 350 as measured at time t334, or more preferably an average voltage taken over a period of time such a t332-t334);
the voltage across the backup power supply 8 at the end of the period of high current discharge U(end) (for example voltage 350 as measured at time t338, or more preferably an average voltage taken over a period of time such a t336-t338);
the voltage across the backup power supply 8 after the end of the period of high current discharge and after a suitable delay to allow for any transient effects in the voltage to die away U(delay) (for example voltage 350 as measured at time t3340, or more preferably an average voltage taken over a period of time such a t340-t3342);
the current discharged from the backup power supply 8 during the period of high current discharge I(discharge) (for example current 352 as measured at time t334, or more preferably an average current taken over a period of time such a t334-t336); and
the current discharged from the backup power supply 8 at the end of the period of high current discharge I(end) (for example current 352 as measured at time t338, or more preferably an average current taken over a period of time such a t336-t338).

Advantageously, by using average values, the calculated values of the capacitance and internal resistance of the backup power supply 8 provide a more effective comparison with reference values for the purpose of ascertaining the condition of the backup power supply 8. Preferably the values of U(start), U(delay) and I(discharge) are averaged over around 500-1000 ms. Preferably the values of U(end) and I(end) are averaged over around 10-50 ms. As noted above, t(discharge) is preferably greater than 1500 ms, and more preferably between 1500-3000 ms, for example 2000 ms. The capacitance C of the backup power supply and the internal resistance R of the backup power supply (also referred to as the equivalent series resistance, or ESR) can be calculated using the equations:

$$R = \frac{U ( delay ) - U ( end ) - U ( disturbance )}{I ( discharge )} and$$

$$C = \frac{I ( discharge ) \times t ( discharge )}{U ( start ) - U ( delay )}$$

wherein U(disturbance) is a voltage loss caused by a disturbance resistance—the disturbance resistance being due to the resistance of the various electrical components and connections in the pitch drive unit involved in carrying the high discharge current (for example any switches, cables, etc. through which the high discharge current flows)—and t(discharge) is the predetermined first time period during which high current discharge of the backup power supply is discharged (for example times t334-t336).

Advantageously, the above equations may be used due to the fact that the high discharge current remains substantially constant during the high current discharge period t(discharge). This in turn means that the capacitance and the internal resistance of the backup power supply can be determined from a single high current discharge period, rather than requiring multiple periods of high discharge. This further reduces the aging effects on the backup power supply 8 that are induced by high current discharge during stress testing, since the backup power supply does not need to be subjected to as many periods of high current in order to ascertain its characteristic properties.

Preferably, if the capacitance C of the backup power supply 8 as calculated using the equations above is greater than or equal to a higher capacitance threshold value, the capacitance C of the backup power supply 8 is deemed to be acceptable. If the capacitance C of the backup power supply 8 is less than the higher capacitance threshold but greater than or equal to a lower capacitance threshold value, preferably a warning is produced, which is preferably transmitted to a wind turbine control facility indicating that the backup power supply 8 may require imminent replacement or repair. If the capacitance C of the backup power supply 8 is less than the lower capacitance threshold, preferably the backup power supply 8 is determined to have failed, and all blades of the wind turbine are put into a feathering position thereby putting the wind turbine into an idle mode.

Preferably, if the internal resistance R of the backup power supply 8 as calculated using the equations above is less than or equal to a lower internal resistance threshold value, the internal resistance R of the backup power supply 8 is deemed to be acceptable. If the internal resistance R of the backup power supply 8 is higher than the lower internal resistance threshold but less than or equal to a higher internal resistance threshold value, preferably a warning is produced, which is preferably transmitted to a wind turbine control facility indicating that the backup power supply 8 may require imminent replacement or repair. If the internal resistance R of the backup power supply 8 is higher than the higher internal resistance threshold, preferably the backup power supply 8 is determined to have failed, and all blades of the wind turbine are put into a feathering position thereby putting the wind turbine into an idle mode.

As an example, a reference value of capacitance can be used to define higher and lower threshold values for capacitance, and similarly a reference value of internal resistance can be used to define higher and lower threshold values for internal resistance, wherein the reference values are either obtained from analysis of similar backup power supplies or datasheet values as discussed above. In one example, the higher capacitance threshold is 80% of a reference value of capacitance, and the lower capacitance threshold is 70% of the reference value of capacitance, wherein the reference value of capacitance is representative of a hypothetical backup power supply in good condition. In the same or different examples, the higher internal resistance threshold is 220% of a reference value of internal resistance, and the lower internal resistance threshold is 200% of the reference value of internal resistance, wherein the reference value of internal resistance is representative of a hypothetical backup power supply in good condition.

During a single testing cycle, there may alternatively be provided more than one period of high discharge current using the method 300, as described above. Advantageously this allows the backup power supply to be stressed at various ranges of backup supply voltage—thus it is beneficially determined whether the backup power supply can operate without breaking down over a range of different voltages, and supply sufficient current over a range of voltages.

Advantageously the above method 300 allows accurate characterisation of backup power supply condition, whilst minimising aging of the backup power supply. By providing one or more short periods of high discharge, the method replicates the stresses placed on a backup power supply during an emergency situation, and thus it is determined whether the backup power supply can operate under such stress without breaking down. Because the high discharge is only performed during short bursts and the backup power supply is not fully discharged, the backup power supply is aged less by the testing process, and accordingly the overall lifetime of the backup power supply is increased. Furthermore, the method above also allows the wind turbine to perform normal power generation for substantially all of the testing procedure, thus increasing the amount of power that can be generated by the wind turbine. Indeed the present method can be implemented arbitrarily often with minimal detrimental effect to power generation.

During the testing procedure t1-t10 the axis control logic 11 of the axis being tested sends a signal 22 to the other axis control logic 13, 14 via bidirectional bus 12a, 12b indicating that the axis is “busy”. On receiving this signal, the other axis control logic 13, 14 determine that the other axes should not begin a testing procedure. Advantageously this provides that only one axis is tested at any one time, thus making sure that enough blades can be put into a feathering position to put the wind turbine into an idle mode in the event of an emergency situation.

As noted above, the present testing method can be carried out arbitrarily often. The testing method may be instigated remotely. For example a remote computing system can transmit a signal via a communications line (not shown) to the axis control logic 11, wherein the signal causes the axis control logic 11 to initiate testing for the backup power supply 8 of that axis. Advantageously this allows for on-demand backup power supply testing without the need to send maintenance personnel to the wind turbine in question. Alternatively, testing could be initialed automatically locally at the wind turbine. For example testing cycles may be initiated at pre-set time intervals by the axis control logic 11, 13, 14. In this embodiment, it is preferred to provide a collision priority list (preferably implemented by control logic 11, 13, 14), which, in the event that test cycle start times for two or more axes coincides (for example due to the provision of separate independent internal clocks that govern the time intervals for testing, for example in each separate axis control logic 11, 13, 14), shifts the test start time for one or more of the backup power supplies such that the start times no longer coincide.

Instructions for carrying out the method of either the first or second embodiments may be stored as executable instructions on a computer readable medium, for execution by software and/or hardware at the control logic 11 of the pitch drive unit/wind turbine 100.

The above discussion provides exemplary embodiments of the present invention. Further aspects of the present invention are described in the appended claim set. The person skilled in the art will appreciate that various modifications can be made to the above disclosure without departing from the scope of the claims.

1. A pitch drive unit for a wind turbine comprising:
a pitch drive motor;
a backup power supply;
a connection to a power grid; and
control logic, wherein the control logic is configured to:
a) monitor the voltage across the backup power supply;
b) monitor the current through the backup power supply;
c) electrically isolate at least the backup power supply and the pitch drive motor from the connection to the power grid;
d) cause the pitch drive motor to operate according to normal power generation procedures, wherein the pitch drive motor draws a first variable current from the backup power supply;
e) discharge the backup power supply at a second variable current over a first period of time, wherein the second variable current is chosen by the control logic such that the first and second variable currents sum to a substantially constant value of current during the first period of time;
f) calculate a characteristic of the backup power supply based on the monitored voltage and current;
g) compare the characteristic to a predefined threshold.

2. The pitch drive unit of claim 1 further comprising a resistive load and power electronics configured to actuate the resistive load;
wherein the control logic is further configured to cause the power electronics to actuate the resistive load such that the resistive load draws the second variable current from the backup power supply over the first period of time.

3. The pitch drive unit of claim 1 wherein:
the pitch drive motor comprises a stator component; and
the control logic is further configured to cause the stator component to draw the second variable current from the backup power supply over the first period of time.

4. The pitch drive of claim 3, wherein the control logic is further configured to control the phase of the second variable current flowing through the stator such that the second variable current causes substantially no torque to be generated in the pitch drive motor.

5. The pitch drive unit of claim 1, wherein the sum of the first and second variable currents corresponds to an emergency current discharged by the backup power, wherein the emergency current is provided to put a rotor blade associated with the pitch drive unit into a feathering position in an emergency situation.

6. The pitch drive unit of claim 1, wherein the control logic is further configured to, based on the comparison of step g), either:
cause the pitch drive motor to put a rotor blade associated with the pitch drive unit into a feathering position based on the comparison; or
electrically connect the backup power supply and the pitch drive motor to the connection to the power grid; or
repeat steps e)-g).

7. A wind turbine comprising the pitch drive unit of claim 1.

8. A method of operating a pitch drive unit for a wind turbine:
a) monitoring the voltage across a backup power supply in the pitch drive unit;
b) monitoring the current through the backup power supply;
c) electrically isolating at least the backup power supply and a pitch drive motor in the pitch drive unit from a connection to a power grid;
d) causing the pitch drive motor to operate according to normal power generation procedures, wherein the pitch drive motor draws a first variable current from the backup power supply;
e) discharging the backup power supply at a second variable current over a first period of time, wherein the second variable current is chosen by the control logic such that the first and second variable currents sum to a substantially constant value of current during the first period of time;
f) calculating a characteristic of the backup power supply based on the monitored voltage and current;
g) comparing the characteristic to a predefined threshold.

9. The method of claim 8 further comprising;
actuating, via power electronics, a resistive load in the pitch drive unit, such that the resistive load draws the second variable current from the backup power supply over the first period of time.

10. The method of claim 8 further comprising causing a stator component in the pitch drive motor to draw the second variable current from the backup power supply over the first period of time.

11. The method of claim 10, further comprising controlling the phase of the second variable current flowing through the stator such that the second variable current causes substantially no torque to be generated in the pitch drive motor.

12. The method of claim 8, wherein the sum of the first and second variable currents corresponds to an emergency current discharged by the backup power, wherein the emergency current is provided to put a rotor blade associated with the pitch drive unit into a feathering position in an emergency situation.

13. The method of claim 8 further comprising, based on the comparison of step g), either:
causing the pitch drive motor to put a rotor blade associated with the pitch drive unit into a feathering position; or
electrically connecting the backup power supply and the pitch drive motor to the connection to the power grid; or
repeating steps e)-g).

14. A method for testing the condition of a backup power supply of an axis in a wind turbine, wherein the backup power supply has an associated voltage, the method comprising:
electrically isolating the axis of the wind turbine from a grid power supply;
whilst the axis is electrically isolated:
during a first time period, discharging the backup power supply at a first predefined current and subsequently measuring a first value of the voltage;
during a second time period, instructing the pitch drive motor to perform normal power generation operations, wherein the pitch drive motor draws power from the backup power supply until the voltage reaches a predefined second value;
calculating a parameter based on at least the first value, wherein the parameter is characteristic of the condition of the backup power supply.

15. The method of claim 14 wherein the first period occurs either before or after the second period.

16. The method of claim 14 wherein the method further comprises:
whilst the axis is electrically isolated:
during a third period of time, discharging the backup power supply at a second predefined current and subsequently measuring a third value of the voltage, wherein the third period is subsequent to the second period and the second period is subsequent to the first period;
calculating the parameter based on at least the first value and the third value.

17. The method of any of claim 14, wherein the first predefined current corresponds to a current provided by the backup power supply when putting a rotor blade of the axis into a feathering position in an emergency situation.

18. The method of any of claim 14, wherein discharging the backup power supply at first predefined current comprises drawing substantially the first predefined current by a pitch converter.

19. The method of claim 16, wherein:
drawing substantially the first predefined current by the pitch drive motor during the first time period comprises:
a) causing the pitch drive motor to rotate a rotor blade of the axis in a first direction and subsequently causing the pitch drive motor to rotate a rotor blade of the axis in a reverse direction; and
b) repeating step a) until the first time period ends.

20. The method of claim 14 wherein:
discharging the backup power supply at first predefined current comprises drawing substantially the first predefined current by a resistive load actuated by power electronics.

21-26. (canceled)
